(19) United States
(12) Patent Application Publication
(10) Pub. No.: US 2021/0117825 A1
(43) Pub. Date: Apr. 22, 2021

(54) METHOD AND SYSTEM FOR PROCESSING A SEARCH RESULT OF A SEARCH ENGINE SYSTEM

(71) Applicant: Visably, LLC, Jackson, WY (US)

(72) Inventors: Christopher Dickey, Jackson, WY (US); Frederick H Seymour, Jackson, WY (US)

(73) Assignee: Visably, LLC, Jackson, WY (US)

(21) Appl. No.: 17/071,920

(22) Filed: Oct. 15, 2020

Related U.S. Application Data
(63) Continuation-in-part of application No. 16/655,468, filed on Oct. 17, 2019.
(60) Provisional application No. 62/915,735, filed on Oct. 16, 2019.

(51) Int. Cl. G06N 5/04; G06F 16/9535; G06F 16/2457; G06F 16/9538; G06Q 30/06; G06Q 30/02; G06N 20/00; G06F 40/289; G06F 40/247

(52) U.S. Cl. CPC G06N 5/04; G06F 16/9535; G06F 16/24578; G06F 16/9538; G06Q 30/0625; G06Q 30/0277; G06Q 30/0246; G06N 20/00; G06F 40/289; G06F 40/247; G06Q 30/0201

(57) ABSTRACT

Disclosed herein is a method including receiving a plurality of references from a search engine system in a search engine results page, as a result of a search performed by the search engine system, wherein each reference links to a resource; determining a position of the reference in the search engine results page; assigning a click through rate to each reference based on the determined position of the respective reference in the search engine results page; retrieving each of the resources identified by the plurality of references; determining, for each of the resources, whether at least one of a keyword and a feature phrase is present therein; and computing a score on the basis of the determined click through rates for the references and the determined presences of the at least one of the keyword and the feature phrase.

### CROSS REFERENCE TO RELATED APPLICATIONS

This patent application claims priority of U.S. Provisional Patent Application Ser. No. 62/915,735, filed on Oct. 16, 2019, and is a continuation-in-part of U.S. Non-Provisional patent application Ser. No. 16/655,468, filed on Oct. 17, 2019, the entire contents of which are incorporated herein by reference.

### BACKGROUND

Search engine systems play a central role in information gathering from the Internet. Examples of search engine systems include Google Search, Baidu, Yahoo! Search, Bing, DuckDuckGo, and many more. A user typically provides a search engine system with a description of the information the user seeks, using a suitable form of presentation such as words, images, and even sounds. The search engine system conducts a search based on the description and returns a result. The result often includes a collection of references to resources that are likely relevant to the information the user seeks.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method including: receiving a plurality of references from a search engine system in a search engine results page, as a result of a search performed by the search engine system, wherein each reference links to a resource; determining a position of the reference in the search engine results page; assigning a click through rate to each reference based on the determined position of the respective reference in the search engine results page; retrieving each of the resources identified by the plurality of references; determining, for each of the resources, whether at least one of a keyword and a feature phrase is present therein; and computing a score on the basis of the determined click through rates for the references and the determined presences of the at least one of the keyword and the feature phrase. Other embodiments of this aspect include corresponding computer systems, apparatus, and computer programs recorded on one or more computer storage devices, each configured to perform the actions of the methods.

In an aspect, the score represents a likelihood of content discovery within the search engine results page.

In an aspect, the method further includes determining whether the resource is a special search engine results page feature designed by the search engine to provide special value to a searcher.

In an aspect, the determining a click through rate includes comparing the determined position to a database of weighted average click through rates for different reference positions in the search engine results page.

In an aspect, each of the references is an organic search result link.

In an aspect, each organic search result on a search engine results page is reviewed the method.

In an aspect, the reference is a Uniform Resource Identifier (URI).

In an aspect, the resource is a document in a markup language.

In an aspect, the resource is a text file.

In an aspect, at least one of the feature words is a set of synonyms.

In an aspect, at least one of the feature words is a set of words sharing a word stem.

In an aspect, the class is selected from the group consisting of paid search results, earned search results, e-commerce search results, and brand-owned search results.

In an aspect, classifying the reference comprises using a random forest machine learning algorithm.

In an aspect, classifying the reference comprises using a neural network machine learning algorithm.

In an aspect, classifying the reference comprises using a Bayesian machine learning algorithm.

In an aspect, the method further includes determining whether the resource includes one or more predetermined keywords.

In an aspect, determining whether the resource includes the one or more predetermined keywords is based on contents of the resource.

In an aspect, determining whether the resource includes the one or more predetermined keywords is based on metadata in the result.

In an aspect, the resource includes one or more predetermined keywords and the method further includes causing rendering of the result on a screen in a human-perceivable form, where a portion of the rendering representing the resource has a visual appearance distinct from that of another portion of the rendering representing another resource not including the one or more predetermined keywords.

In an aspect, the method further includes determining a fraction of references that are in the class and point to resources including one or more predetermined keywords among all references in the class.

In an aspect, the method further includes computing a score representing prevalence of one or more predetermined keywords in resources represented in the result.

A computer program product including a non-transitory computer readable medium having instructions recorded thereon, the instructions when executed by a computer implementing the method. Some implementations of the described techniques include hardware, a method or process, or computer software on a non-transitory computer-readable medium.

This summary is neither intended nor should it be construed as being representative of the full extent and scope of the described systems and methods. Moreover, references made herein to “the present disclosure,” or aspects thereof, should be understood to mean certain embodiments of the present methods and systems and should not necessarily be construed as limiting all embodiments to a particular description. The present disclosure is set forth in various levels of detail in this summary as well as in the attached drawings and the Detailed Description and no limitation as to the scope of the present disclosure is intended by either the inclusion or non-inclusion of elements, components, and etc. in this summary Additional aspects of the described methods and systems will become readily apparent from the Detailed Description, particularly when taken together with the Figures.

### BRIEF DESCRIPTION OF FIGURES

FIG. 1 schematically shows a result of a search performed by a search engine system.

FIG. 2 schematically shows that, when a reference in the result is received from the search engine system by a server, the server retrieves the resource that the reference points to.

FIG. 3 schematically shows that the server determines the frequencies of occurrence of a plurality of feature words in the resource and classifies the resource based on the frequencies of occurrence.

FIG. 4 schematically shows that a classifier used in the process of FIG. 3 is trained using a training data set, in an example.

FIG. 5 schematically shows an example of classified references in the result.

FIG. 6 schematically shows an example where a portion of the rendering representing the resources including a predetermined keyword has a visual appearance distinct from that of another portion of the rendering representing other resources not including the predetermined keyword.

FIG. 7 schematically shows examples of a fraction of the references that are in a given class and include a predetermined keyword among all the references in that class.

FIG. 8 schematically shows an example of a score being displayed on a screen.

### DETAILED DESCRIPTION

Although a search engine system sometimes classifies the references in the result, the classification may not suit the needs of every user or may exclude information that is not explicitly provided to the search engine system. In an example where the description includes running shoes, the result may include advertising, a list of websites selling running shoes, a map or a list of brick-and-mortar stores that sell running shoes in the vicinity of the user, and a list of “organic” references pointing to online resources relevant to running shoes. The result in this example can be useful to a consumer looking for running shoes to purchase but may not be so to a marketer managing a running shoe brand who wishes to understand the various marketing channels through which consumers may engage with the running shoe brand when using a search engine system. Marketers need to know how their brand is performing in search results that are non-branded but related to their products and services. Searching directly for the brand will result in predictable search results that are about the brand but are not necessarily representative of how a customer may search for product advice or recommendations. Marketers need to repeat the customer discovery process that often includes related but non-branded search terms, by identifying where their brand may exist or be absent in a search result across marketing channels that they do not directly control (e.g., e-commerce and earned media) as well as those they do control (e.g., brand-owned and paid media).

Disclosed herein are methods, and a computer program product embodying the methods, for classifying the references in the result of a search performed by the search engine system. In an example, the references are classified into four classes: paid references, earned references, e-commerce references, and brand-owned references. The class of “paid references” includes those references whose placement in the result is purchased. The presentation of a reference in the class of “paid references” is usually determined by the purchaser, at least to some extent. The class of “earned references” includes those references whose placement in the result is not purchased (often called “organic”) and included in the result by the search engine system based on the relevance of the resources they point to with the description. One example of a reference in the class of “earned references” is one pointing to an online journalism website. The class of “e-commerce references” includes those references whose placement in the result is not purchased and pointing to websites whose primary business activity is to electronically retail other companies' branded products or services. One example of a reference in the class of “e-commerce references” is one pointing to a website of a department store. The class of “brand-owned references” includes those references whose placement in the result is not purchased and pointing to websites whose primary business activity is to electronically market the website owners' branded products or services. An example of a reference in the class of “brand-owned references” is one pointing to a website of a name brand. In an example, the class of “brand-owned references” are also be further categorized as transactional and informational. In an example, transactional “brand-owned references” are defined as such when the primary business activity of the root domain is to promote and sell products and services that are directly produced by the business which owns and operates the website and the page is commerce related, for example a product or service can be purchased. Informational “brand-owned references” are also pages where the primary business activity of the root domain is to promote and sell products and services that are directly produced by the business that owns and operates the website, however the page presents informational or educational content, that is, the page is not a sales page. In an example, other suitable classes are used, including “government”, “educational”, “reference”, “internet tools” such as clocks and calculators, “affiliate” sites whose primary purpose is to provide “buy now” links but offer no unique commentary or method to purchase directly through the site, “adult”, “entertainment”, “political”, “forum”, “social media” and the like. In an example, these classes are mutually exclusive (i.e., no reference in the result falls into more than one class). In an example, these classes are collectively exhaustive (i.e., each reference in the result must fall into at least one class).

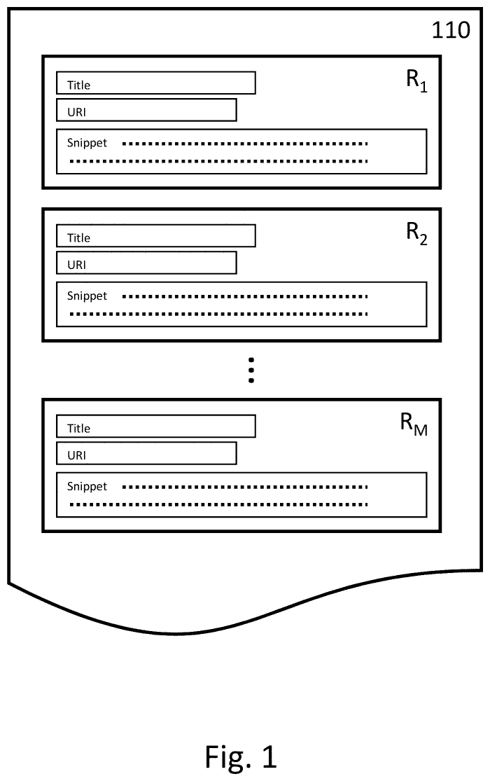

FIG. 1 schematically shows the result 110 of a search performed by the search engine system. The result 110 includes multiple references R₁, R₂, . . . , R_{M}. The references may be presented in any suitable way. In an example, each of the references includes a title, a Uniform Resource Identifier (URI), and a snippet of the resource pointed to. In an example, the presentation of the references is paginated. In an example, the resources pointed to by the references are located on one or more servers remote from the user. In an example, the resource is a text file. In an example, the resource is a document in a markup language (e.g., HTML, XHTML, XML).

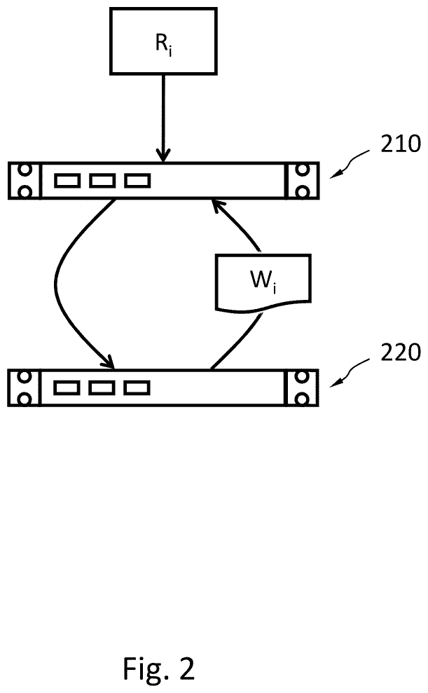

As schematically shown in FIG. 2, when a reference Rᵢ in the result 110 is received from the search engine system by a server 210, the server 210 retrieves the resource Wᵢ that the reference Rᵢ points to. For example, the server 210 sends a request to a remote server 220 hosting the resource Wᵢ and receives the resource Wᵢ from the remote server 220.

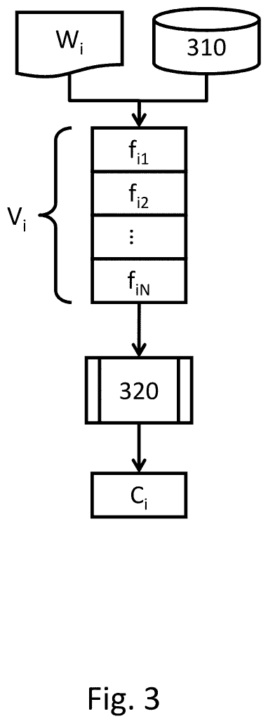

As schematically shown in FIG. 3, the server 210 determines the frequencies of occurrence of a plurality of feature words {F₁, F₂, . . . , F_{N}} in the resource Wᵢ. The feature words are members of a predetermined set 310 of words. In an example, the predetermined set of words is stored in a feature words library. In an example, the server 210 determines the frequency fᵢⱼ of occurrence of a feature word Fⱼ by counting the number Oᵢⱼ of occurrence of that feature word Fⱼ in the resource Wᵢ and dividing the number Oᵢⱼ of occurrence by the sum of the numbers of occurrence of all feature words in the resource Wᵢ, wherein j is an integer in the interval [1, N]. In other words, in this example, fᵢⱼ=Oᵢⱼ/ΣₖOᵢⱼ. In an example, at least one of the feature words is a set of synonyms. For example, a feature word is the set {car, vehicle, automobile}. In an example, at least one of the feature words is a set of words sharing the word stem. For example, a feature word is the set {drive, drove, driven, drives, driving, driver, drivers}. In an example, the frequencies of occurrence of the feature words are organized as a feature vector Vᵢ for the reference Rᵢ pointing to the resource Wᵢ. The server 210 classifies the reference Rᵢ into a class Cᵢ based on the frequencies of occurrence, fᵢⱼ, j=1, 2, . . . , N, using a classifier 320. In an example, the feature words are representative of desired content.

In an example, the resource Wᵢ is preprocessed before the frequencies fᵢⱼ of occurrence are determined. For example, the encoding of the resource Wᵢ is converted (e.g., into ASCII), leading and trailing spaces are removed from the resource Wᵢ, non-numeric and non-alphabetic characters are removed from the resource Wᵢ, words too short (e.g., shorter than 3 characters) and too long (e.g., longer than 15 characters) are removed from the resource Wᵢ, synonyms in the resource Wᵢ are made the same word, or words sharing the same word stem in the resource Wᵢ are made the same word.

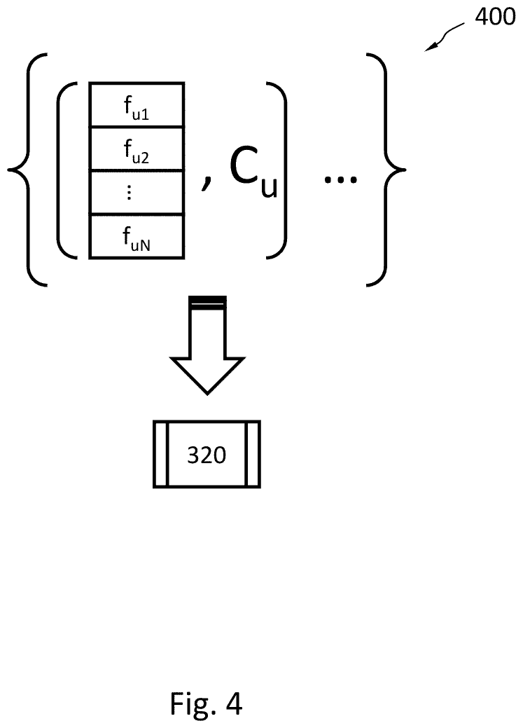

In an example, the classifier 320 uses a random forest machine learning algorithm but the classifier 320 is not limited to the random forest machine learning algorithm. As schematically shown in the example of FIG. 4, the classifier 320 is trained using a training data set 400. In an example, the training data set 400 includes frequencies {fᵤ₁, fᵤ₂, . . . , f_{uN}} of occurrence of the feature words {F₁, F₂, . . . , F_{N}} in multiple resources {Wᵤ, u=1, 2, . . . } and the classes {Cᵤ, u=1, 2, . . . } these resources belong to. The classes {Cᵤ} may be determined manually or using any other suitable method.

In an example, the classes {Cᵤ} are determined using a neural network machine learning algorithm. As used herein, the term “neural network machine learning algorithm” is an algorithm using a neural network (NN), also called artificial neural network (ANN). An NN can be implemented in a computing system where multiple nodes, also called artificial neurons, are connected. A node receives data from a first set of one or more nodes, processes the data and transmits the result to a second set of one or more nodes. By adjusting the connections among the nodes, the NN is “trained” for solving a problem (e.g., classification).

In an example, the classes {Cᵤ} are determined using a Bayesian machine learning algorithm. As used herein, the term “Bayesian machine learning algorithm” is an algorithm using Bayesian inference, which is a method of statistical inference in which Bayes' theorem is used to update the probability for a hypothesis as more evidence or information becomes available.

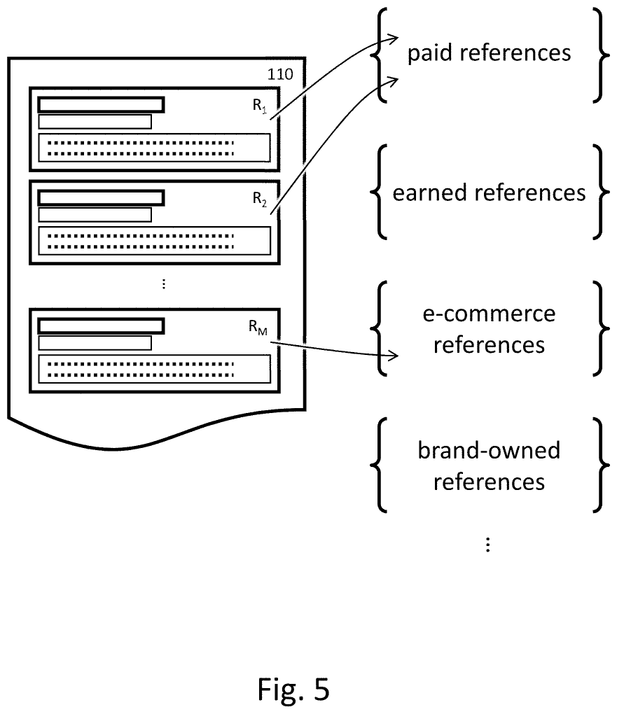

FIG. 5 schematically shows that the references {Rᵢ, i=1, 2, . . . , M} in the result 110 are classified into various classes using the system and method presented above. In this example, some of the references {Rᵢ} are put into the same class (e.g., R₁ and R₂ both put into the class “paid references”). In this example, none of the references MI is put into some (e.g., the class “brand-owned references”) of the classes.

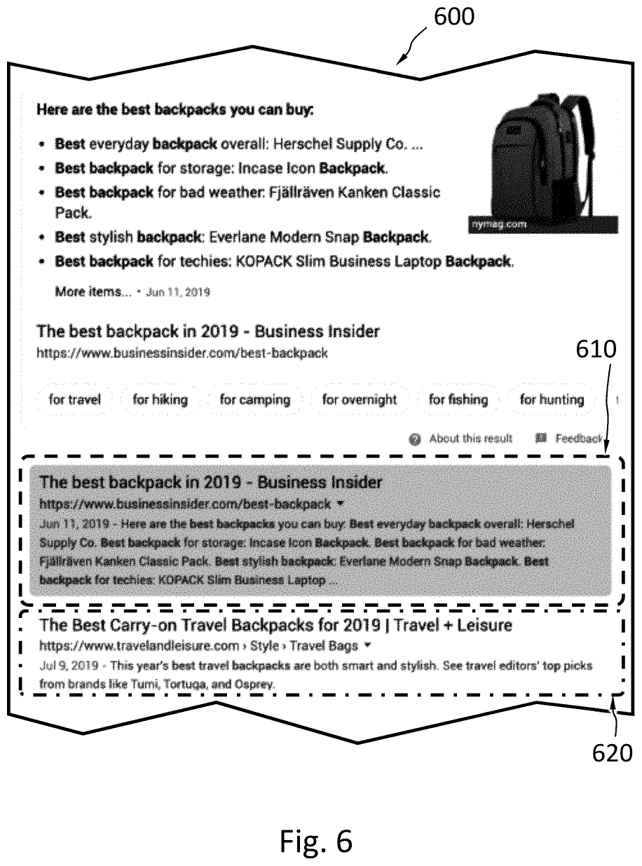

In an example, the server 210 determines whether the resources {Wᵢ} pointed to by the references {Rᵢ} in the result 110 include a predetermined keyword. In an example, this determination is based on the contents of the resources {Wᵢ}. In an example, this determination is based on metadata in the result 110. The metadata are information in the result 110 that are not part of any of the references {Rᵢ}. In an example, the predetermined keyword is a brand. In an example, the server 210 causes rendering of the result 110 on a screen in a human-perceivable form (e.g., texts, graphs, images, audios and videos). In an example, the screen is on a device remote to the server 210. As schematically shown in the example of FIG. 6, a portion 610 of the rendering 600 representing the resources including the predetermined keyword has a visual appearance distinct from that of another portion 620 of the rendering 600 representing other resources not including the predetermined keyword. For example, the portion 610 has a different background, size, font or color from that of the portion 620.

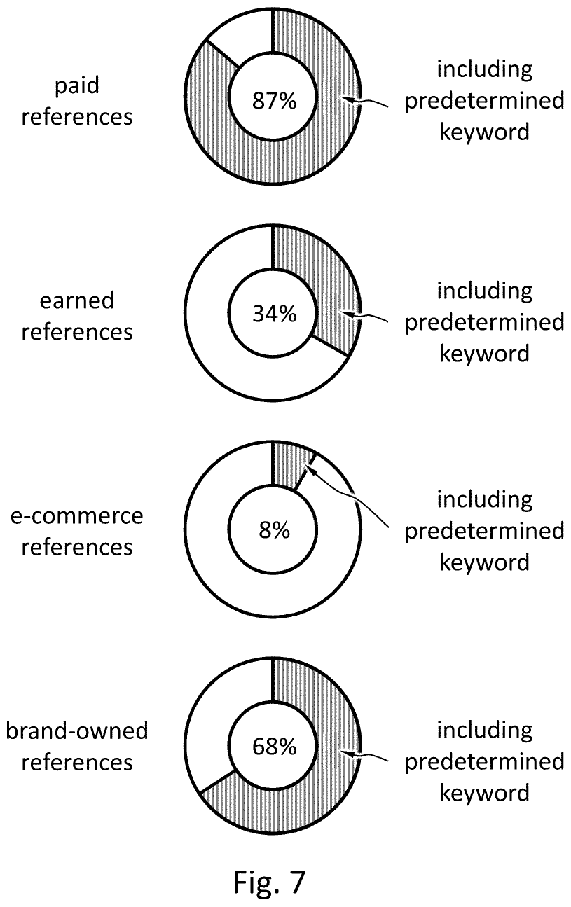

In an example, the server 210 determines a fraction of the references that are in a class and include a predetermined keyword among all the references in that class. As schematically shown in the example of FIG. 7, 87% of the references in the class “paid references” point to resources including the predetermined keyword, 34% of the references in the class “earned references” point to resources including the predetermined keyword, 8% of the references in the class “e-commerce references” point to resources including the predetermined keyword, and 68% of the references in the class “brand-owned references” point to resources including the predetermined keyword. In an example, the server 210 causes rendering of the fractions on a screen in a human-perceivable form (e.g., a donut chart).

In an example, the websites listed in a search engine results page (SERP) are categorized using machine learning. In the example, a URL database is prebuilt using, for example, whois data, website listings of top visited websites, databases including data collected by web crawling, early customer feed back and the like. The machine learning algorithm can be trained using training data collected using a URL collection method, wherein the training data is labeled using criteria for a plurality of categories. In an example, each categorization is assigned a confidence level, for example, high and low. Parked domains can be determined, for example, where domains have recently expired and are registered to organizations which have more than, for example, 10,000 domains registered to the organization. Data can then be scraped from the URLs collected and be preprocessed and text can be extracted. For example, each URL file can be converted to ascii, broken into lines with leading and trailing spaces removed, then be split into phrases and subsequently into individual words. Non-numeric and non-alphabetic characters can be skipped. New words are added to the list and all word occurrences can be counted. The aforementioned provides a list of unique words found with the associated occurrence count. Words can be filtered out or removed from the list according to criteria, for example, if the word has less than three characters or more than fifteen characters. The words can then be lemmatized.

The feature frequencies can then be counted. The remaining lemmas can be sorted in order of frequency of occurrence. Highly similar lemmas can, for example, be identified using wordnet, synsets. The lower occurrence lemma can in each instance be mapped to the higher occurrence word. The counting of feature frequencies can include saving a lemmas list and a similarity word table as CSV files. All the html tags counts can be counted and the count is stored. Similarly, all URL link word counts can be counted and the count is stored.

In the example, features can then be created. The lemmas list and similarity lemmas frequency table CSV files are loaded. URL binary files can be sequentially loaded from a local disk. For each URL file: a record is created which is used for training or classification; similar words are merged according to the similar word table; relative lemma counts from the lemma list and extracted html text are tabulated and saved as feature variables; relative HTML tag counts can be tabulated and saved as feature variables; and URL link word counts can be tabulated and saved as feature variables. The resulting array of URL feature variables can be stored, for example as a CSV file.

In the example, the URL feature variable is loaded for the random forest training model and classification. The data is split into training datasets and test datasets with random record selections. Calculated feature variables are created, for example weighted averages from the training dataset. In an example, the random forest model is then built using the training data set and manually selected URL categories. The random forest model may use 100 trees and the square root of the total number of features in each tree. The random forest can run for multiple epochs until convergence and determine feature importance so as to aid in deciding which features should be omitted in future iterations of the model.

In the example, the model's performance can be evaluated by having the model predict the URL categories on the test dataset and compare the predictions to the manually determined URL categories. The trained random forest model is then stored.

For model inference, the random forest model and all necessary code can be baked for example into a Docker image. The model may, for example, process one URL at a time. The steps of pre-processing and text extraction, counting of feature frequency and feature creation are performed to create feature data. The feature data can then be fed through the random forest model. Low confidence predictions can be filtered out and a “nonce” category can be assigned. All predictions can be written to a file, for example a CSV file, for use in the production system.

In a further example, the server 210 computes a score representing the prevalence of the predetermined keyword in resources represented in the result 110. In an example, the server 210 causes rendering of the fractions on a screen in a human-perceivable form.

The score can represent a likelihood of specific desired content being discovered in a SERP by a user. The score may, for example, be represented as x/100 wherein a low score indicates a lesser likelihood of the content being discovered and a higher score indicates a higher likelihood the content will be discovered. The score can be calculated by creating a weighted point system which dynamically identifies and applies numerical values to SERP features that include the desired content. A score can then be derived by dividing the sum of points from the SERP features that include the desired content by the total amount of points available on the page.

In an example, the score is determined using a Click-Through-Rate (CTR) and brand value. Each SERP feature has a numerical point value applied thereto based on a weighted average CTR of the respective SERP feature. The CTR is dependent on where the feature is positioned in the SERP and on the dynamic combination of other features present in the SERP. A special SERP feature is defined as a feature which is not an advertisement or a normally presented organic search result link. Special SERP features are designed by the search engine to provide special value to the person performing the search and have a notable effect on the CTR of the other features presented in the SERP. A determined CTR for every position of a link within the SERP as well as for special SERP features can be stored, for example, in a list. The list of determined CTR for the different link positions and special SERP feature positions can be used in calculating the score. If no SERP feature combination is recognized within the list of predetermined combinations, the score can default to a list of weighted CTR averages.

The value of a brand among other considerations also can affect the point value a SERP feature receives. For example, if the root domain of the SERP feature is owned by the entity examining the content, the feature receives a multiplier. A further example of where a multiplier is applied is where the SERP feature includes a branded image or the SERP feature is determined to be a no-click feature.

According to the exemplary embodiment, all the SERP features that include the desired content are identified by adding up the total accrued point values for the identified features. The total number of possible point value of all the SERP features is presented within the result page. The total number of points can be calculated according to Total Possible Points=((Average CTR of SERP Feature)×(Brand Value Multiplier))+n1+n2+n3 . . . .

The score is then determined by dividing the total points received by the SERP features that include the desired content by the total possible points determined according to the formula above.

Score=(Total Points received by content-positive SERP Features)/(Total Possible Points).

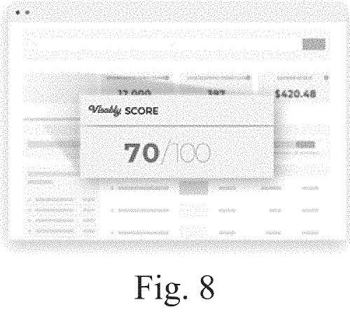

FIG. 8 shows a score which measures the likelihood of content discovery displayed on a display for a user. In an example, the score is shown as x/100.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving a plurality of references from a search engine system in a search engine results page, as a result of a search performed by the search engine system, wherein each reference links to a resource;
determining a position of the reference in the search engine results page;
assigning a click through rate to each reference based on the determined position of the respective reference in the search engine results page;
retrieving each of the resources identified by the plurality of references;
determining, for each of the resources, whether at least one of a keyword and a feature phrase is present therein; and
computing a score on the basis of the determined click through rates for the references and the determined presences of the at least one of the keyword and the feature phrase.

2. The method of claim 1, wherein the score represents a likelihood of content discovery within the search engine results page.

3. The method of claim 1 further comprising determining whether the resource is a special search engine results page feature designed by the search engine to provide special value to a searcher.

4. The method of claim 1, wherein said determining a click through rate includes comparing the determined position to a database of weighted average click through rates for different reference positions in the search engine results page.

5. The method of claim 1 further comprising:
determining whether the reference includes a root domain which is brand-owned by an entity examining content with the search engine results page; and,
applying a multiplier to the reference if the root domain is brand-owned by the entity.

6. The method of claim 1 further comprising:
determining whether the reference includes a branded image; and,
applying a multiplier to the reference if the reference is determined to include a branded image.

7. The method of claim 1, wherein each of the references is an organic search result link.

8. The method of claim 1, wherein the reference is a Uniform Resource Identifier (URI).

9. The method of claim 1, wherein said determining, for each of the resources, whether at least one of a keyword and a feature phrase is present therein includes determining whether synonyms of the at least one of the keyword and feature phrase are present therein.

10. The method of claim 1, wherein the resource is a document in a markup language.

11. The method of claim 1, wherein the resource is a text file.

12. The method of claim 1, wherein the keyword is a word stem.

13. The method of claim 1 further comprising classifying the reference into a class based on the frequencies of occurrence wherein the class is selected from the group consisting of paid search results, earned search results, e-commerce search results, and brand-owned search results.

14. The method of claim 13, wherein classifying the reference comprises at least one of using a Bayesian machine learning algorithm, using a neural network machine learning algorithm, and using a random forest machine learning algorithm.

15. The method of claim 1, further comprising determining whether the resource includes a plurality of predetermined keyword.

16. The method of claim 15, wherein determining whether the resource includes the one or more predetermined keywords is based on contents of the resource.

17. The method of claim 15, wherein determining whether the resource includes the one or more predetermined keywords is based on metadata in the result.

18. The method of claim 1,
wherein the resource includes one or more predetermined keywords;
wherein the method further comprises causing rendering of the score on a screen in a human-perceivable form; and
wherein a portion of the rendering representing the resource has a visual appearance distinct from that of another portion of the rendering representing another resource not including the one or more predetermined keywords.

19. The method of claim 13, further comprising determining a fraction of references that are in the class and point to resources including one or more predetermined keywords among all references in the class.

20. A computer program product comprising a non-transitory computer readable medium having instructions recorded thereon, the instructions when executed by a computer implementing the method of claim 1.
